(19) United States
(12) Patent Application Publication
(10) Pub. No.: US 2017/0024519 A1
(43) Pub. Date: Jan. 26, 2017

(54) SYSTEM FOR LAB RESULTS BASED DATING COORDINATION

(71) Applicant: SEROMATCH, INC., Oak Point, TX (US)

(72) Inventor: DEREK FARLEY, OAK POINT, TX (US)

(21) Appl. No.: 15/178,413

(22) Filed: Jun. 9, 2016

Related U.S. Application Data
(60) Provisional application No. 62/173,214, filed on Jun. 9, 2015.

(51) Int. Cl. G06F 19/00; G06Q 50/00

(52) U.S. Cl. CPC G06F 19/322; G06Q 50/01; G06F 19/3418

(57) ABSTRACT

What is disclosed is a lab based system for facilitating dating between two or more individuals in which the system matches users by any number of factors but including the factor of what, if any, STD each user is infected with. Users are matched based on STD infection or non infection such that users having the same STD and/or strain of STD are matched together, amongst other potential criteria. In a preferred embodiment, the system further tracks the duration of time that has elapsed and displays that information to each user and/or each user's prospective matches for purposes of, for example, increasing the accuracy of data regarding each user's STD rate and to facilitate ongoing STD testing amongst users.

### PRIORITY/CROSS-REFERENCE TO RELATED APPLICATIONS

This application claims the benefit of U.S. Provisional Application No. 62/173,214, filed Jun. 9, 2015, the disclosure of which is incorporated by reference.

### TECHNICAL FIELD

The disclosure generally relates to the field of dating facilitating systems. Particular embodiments relate to providing an online dating system utilizing a secure, confidential results based dating system based on the confidential results of a sexually transmitted disease test and to a system of supporting a dating system by providing secure, confidential service of matching users infected or uninfected by the same sexually transmitted disease or the same strain of sexually transmitted disease.

### BACKGROUND

Dating systems, including online dating systems, allow people to interact and communicate with each other based on a variety of matching criteria. These dating systems can function as social networks that provide people the ability to further both platonic and sexual relationships. Various online dating websites have been developed. Typically online dating websites operate by providing an online situated meeting place for individuals or groups that share similar characteristics, activities, and/or social likes. These online dating systems typically provide users a mechanism by which they can contact similar other users.

In many of these dating systems users are selected or paired with other users based on the matching of characteristics, activities, and/or social likes of these users. One potential issue for online dating systems is that a percentage of the general population is infected by one or more sexually transmitted diseases (STD's). Without screening for the infection of sexual transmitted diseases, dating systems could be unwillingly, or unknowingly, facilitating the spread of a sexually transmitted disease. What is needed is a secure, reliable system for testing and informing users of a dating system as to the infection of such a user with a sexually transmitted disease and a system by which users of online or non-online dating systems can be matched to other users based on the confidential results of the test(s) for sexually transmitted diseases yet the results of each user's sexually transmitted disease testing is maintained confidentially by the system.

### SUMMARY OF THE DISCLOSURE

The purpose of the Summary is to enable the public, and especially the scientists, engineers, and practitioners in the art who are not familiar with patent or legal terms or phraseology, to determine quickly from a cursory inspection, the nature and essence of the technical disclosure of the application. The Summary is neither intended to define the inventive concept(s) of the application, which is measured by the claims, nor is it intended to be limiting as to the scope of the inventive concept(s) in any way.

What is disclosed is a dating system, either in an online or non-online format, and a system for supporting a dating system that provides for a confidential, secure method and system of testing and matching users who are or are not infected by one or more sexually transmitted diseases with users having a matching prognosis. A matching user is typically considered to be a user infected by the same sexually transmitted diseases or strain of sexually transmitted diseases and whose test results indicate the absence of the same sexually transmitted diseases or strain of diseases as the matched user.

The dating system, in a preferred embodiment, includes testing a first user for the infection of a series of sexually transmitted diseases. A second user is also tested for a series of sexually transmitted diseases. These test results may be used as a profile or may be considered as a portion of a profile of the first user and of the second user. In a preferred embodiment, each profile is then considered in matching with a profile of another user. If a match is found between the profiles of the first user and the profile of the second user, the first user and the second user are provided with the option of contacting the other matching user(s).

In a preferred embodiment, the system includes the option of testing a plurality of users with each user's test results and/or profile stratified into groups based on the results of the user's sexually transmitted disease tests. The user's sexually transmitted disease tests are also considered as a portion of a profile with potentially a user's characteristics, activities, and/or social likes are considered as part of this profile. The user's characteristics, activities, and/or social likes can include, but are not limited to, the user's preferred choice of features in a potential mate, the user's social activities such as sports played or hobbies, a user's likes in television, movies, or video game preferences, a user's political affiliation, education level, or religious affiliation and/or non-affiliation, and a user's personality type.

In a preferred embodiment prior to directly matching two users as a match, at least one user's profile, and preferably every user's profile, is categorized into a subcategory based on one or more of the following exemplary categories: STD positive and STD negative; categories base on the type of STD and/or strain of STD the user is infected with; and/or whether the user's STD is curable or not. It is noted that the categories provided are exemplary and are not limited only to those categories disclosed herein. In a preferred embodiment the categorization of users is performed by a processor, although the categorization can be performed manually by a system operator or other person or group.

In a preferred embodiment, the matching of the user's profiles occurs by stratifying the profiles of a group of users into different groups based upon the presence or absence of a sexually transmitted disease and potentially other factors such as a user's characteristics, activities, and/or social likes. After a match has been found, two matching users can be provided with the mechanism to contact users having matching profiles. Alternatively, after a match has been found each matching user can be presented with a summary or non-confidential profile of the other matching user for approval or disapproval of the match. If both of the matching pair (or matching group) approves, the dating system will then provide each user with a method of contacting the other user or with the contact information of the other user, such as with an email address or a telephone number.

In a preferred embodiment, a primary feature of the disclosed system is that the sexually transmitted disease testing is undertaken as a confidential aspect of the system. Results from each user's sexually transmitted disease test are kept confidential, except generally to the user whose results the tests are directed to, and when a match occurs the results are not provided as to what diseases are matched. Accordingly, no confidential data is disclosed between the system and a user, unless the results belong to that specific user.

In a preferred embodiment, a processor is used in order to enhance and expedite the matching process. This processor can be a variety of processors known in the art including a computer. In an online dating scenario, a user can be notified of a match with another user by electronic mail, text message, or instant message.

In a preferred embodiment, the dating system can be provided in an online profile in which a user registers for the dating service online, the user is directed to an associated sexually transmitted disease testing center that can include, for example, a doctor's office or clinic. In a preferred embodiment, the system provides a reference to a sexually transmitted disease testing location that is proximate to the user.

In a further preferred embodiment, the dating system includes providing a referral to a user diagnosed with the sexually transmitted disease to a physician located proximate to the location to a user diagnosed with the sexually transmitted disease.

The term “online” as utilized throughout this document includes dating systems that utilize software applications found on phones, commonly called “apps”. Embodiments of the invention can utilize applications, including dating system specific applications, to connect users through each user's mobile device, such as a tablet, cellular phone, or other portable device.

The app can be configured to utilize location services provided through, for example, global positioning satellite (GPS), WIFI location triangulation, or cell phone tower triangulation. A wide variety of location services, either currently known or developed in the future, can be utilized without departing from the spirit of the inventive concept(s) disclosed in the application. The location services can be utilized to facilitate matching and user interface based on the location of one user relative to another user as, for example, a further category in the profile matching step or to allow users to potentially meet with matched users proximate in geographic location. The location services function can be configured with varying security levels such that a user can select the level to which a user's location is displayed or discoverable through the application. The location services security can be configured through the application settings and/or through the user's mobile device settings.

In a preferred embodiment, when a first user is notified of a match with a second user, the first user is provided with the option of approving or disapproving of the match. The second user can also be provided with the option of approving or disapproving of the match with the first user. If both the first user and the second user approve of the match, the system provides the first user with the second user's contact information. The second user is also provided with the first user's contact information in a preferred embodiment. Alternatively, the system can provide a mechanism, such as an instant messenger function or private message system included in the system, for each user to contact the other. In a preferred embodiment, a system is be provided in conjunction with or in support of a pre-existing dating system, for example but not limited to currently known systems Match.com, eharmony.com, or Tinder.

In a preferred embodiment the duration since each user's last STD test is calculated by the processor. In a preferred embodiment the processor prompts each user once a set duration has expired since the user's most recent STD test. The processor can further serve to display the amount of time that has elapsed since a user's most recent STD test to matching users. This function can serve to increase the accuracy of each user's profile by encouraging users to obtain more frequent STD tests. The processor can further be configured to prompt a user to disclose the most recent incident of sexual activity in which a user may have been exposed to an STD in an attempt to ensure that STD test results for each user are accurate.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

What is disclosed is a dating system having a series of steps. In a preferred embodiment, the dating system includes the step of testing a first user for infection of a series of sexually transmitted diseases (STDs) and testing a second user for infection of a series of STDs to obtain test results for each user indicating infection of a STD. The term, series, includes one or more STDs. In a preferred embodiment the system further includes the step of creating a profile of first user and second user, wherein profiles of users comprise test results indicating the infection and/or absence of each STD in a series of STDs.

The system further includes the step of matching compatible profiles of users by comparing their profiles for the infection and/or absence of each STD. In a further preferred embodiment this is achieved by using one or more processing devices to match compatible profiles of users. In a further embodiment this step comprises stratifying said profiles into groups based on the results of tests for the infection of STDs.

The system further includes the step of notifying users of matches which are defined as when a user's profile and another user's profile are positive or negative for the same STDs in a series of tests for STDs. In a further preferred embodiment, this step includes notifying a first user and a second user of a match without disclosing any of the actual test results for the infection or absence of a STD from testing first user to second user or of second user to first user. In a further preferred embodiment, this step includes electronically mailing (emailing) a user when user's profile has been matched with a second user's profile. In a further preferred embodiment, this step includes providing a first user and a second user with the ability to approve of or disapprove of the results of the matching analysis as well as providing a first user and a second user with contact information after a first user and a second user approve of the results of the matching analysis.

In a further preferred embodiment, the dating system includes the step of notifying a user of the results of his/her test for the infection or absence of a STD. In a further preferred embodiment, the dating system includes the step of providing an online platform for a user to register for the dating system. In a further preferred embodiment, the dating system includes the step of providing the location of STD testing locations proximate to the location of a user who registered online for the dating system as well as the step of providing a tele-medical treatment to a user diagnosed with the infection of a sexually treated disease. In a further preferred embodiment, the dating system includes the step of providing a referral to a user diagnosed with the infection of a STD to a physician located proximate to the location of a user diagnosed with a STD.

In a further preferred embodiment the dating system includes the step of providing the contact information for a user whose profile has been placed in a group to other users whose profiles have been placed in the same group. In a further preferred embodiment the dating system includes the step of providing the system to a user of a pre-existing dating system and/or the system is integrated with a pre-existing dating system. In a further preferred embodiment, the dating system includes the step of displaying to a user the duration of time elapsed since the user's most recent STD test as well as the step of displaying the duration of time since a user's last STD test when displaying the profile of each user to a matching user's profile. In a further preferred embodiment, the dating system includes the step of providing a processor, wherein the step of matching compatible profiles of users by comparing the profiles of a first user and a second user for the infection and/or absence of each STD is performed by the processor.

### BRIEF DESCRIPTION OF THE DRAWINGS

FIG. 1 illustrates a flow chart of a preferred embodiment of an operating schematic of an online lab results based dating system when a match between users occurs.

FIG. 2 illustrates a flow chart of a preferred embodiment of an operating schematic of an online lab results based dating system when a match between two or more users is not found.

FIG. 3 illustrates a flow chart of a preferred embodiment of an operating schematic of an online lab results based dating system in which user's profiles are stratified into separate groups before the system attempts to match users' profiles.

### DETAILED DESCRIPTION OF THE PREFERRED EMBODIMENTS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

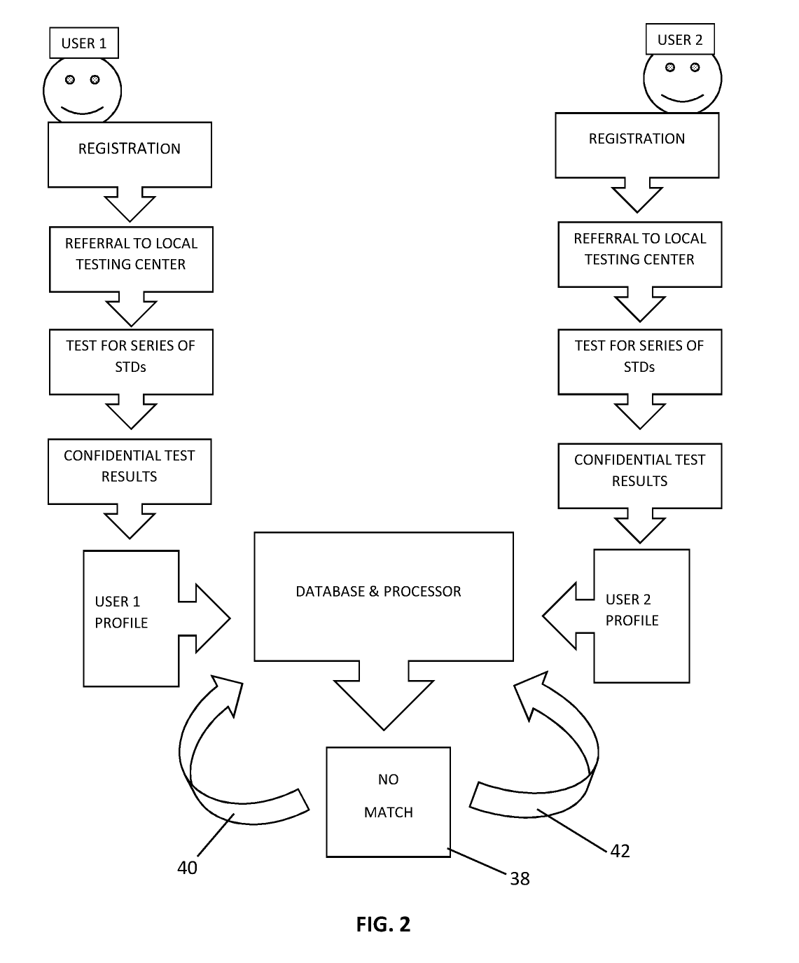

FIG. 2 illustrates a flow diagram of a preferred embodiment of the disclosed lab results based dating system in which two user's profiles have matched. A first user 2 and a second user 4 register 6, 8 for the dating service and/or STD testing service. The users are then referred 10, 12 to a local testing center, although the option for remote testing may be possible in alternate embodiments. The users are tested 14, 18 for one or more STD's. The users are subsequently notified, preferably confidentially notified, 18, 20 of their STD test results. In a preferred embodiment the users can decide after they receive their test results if they want to enter the dating system by registering for the dating system. Alternatively, if the users have already agreed to enter into the dating system, the profile of each user is entered into a database 24 and a processor attempts to match the profile of each user to another user 26. The processor can be in a same physical location as the database or can be remote from the database.

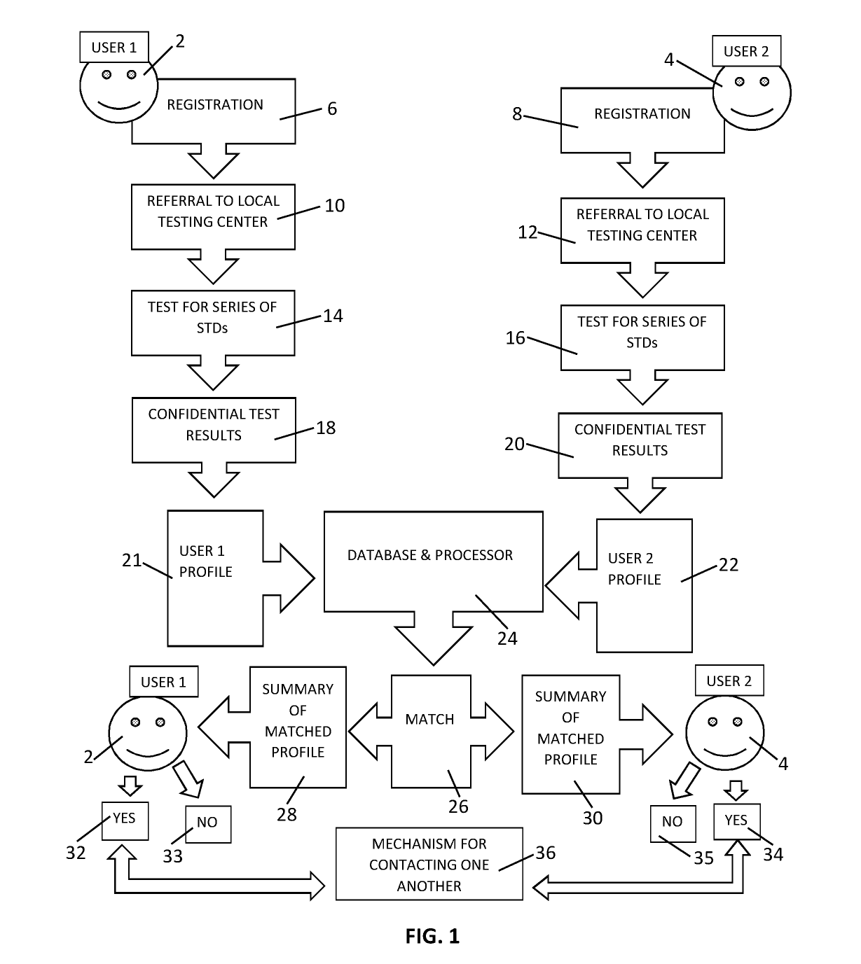

The processor can further be used to match additional characteristics of the users beyond the STD infection data of each user. For example, users may be asked to input their own physical characteristics and/or social characteristics and the characteristics they seek in an ideal match. Similarly, photographs of each user may be included in the profile in order to allow for further refinement of user matches. If the processor determines a match has occurred 26, a complete matching profile and/or a summary of the matching profile is made available 28 to the matched users. The matched users 2, 4 are then able to select if they desire to continue with their selected match. In FIG. 1 this is depicted by boxes yes 32, 34 or no 33, 35. If both users select “yes” or an analogous choice, the contact information or other method of contacting the user is provided. This can be allowed, for example, by providing personal contact information or by providing a mechanism within the dating platform for two or more users to contact one another. If one or more users selects the “no” function or another analogous function, the users are re-entered into the database for subsequent matching. Alternatively each user can continue to be presented with matches subsequent to being matched and contacting a matching party.

FIG. 2 illustrates a preferred embodiment of the system in which no match 38 has occurred between two or more users. When no match occurs, the two users profiles continue in the database and the processor continues to attempt to match 40, 42 the profile of each user with another user.

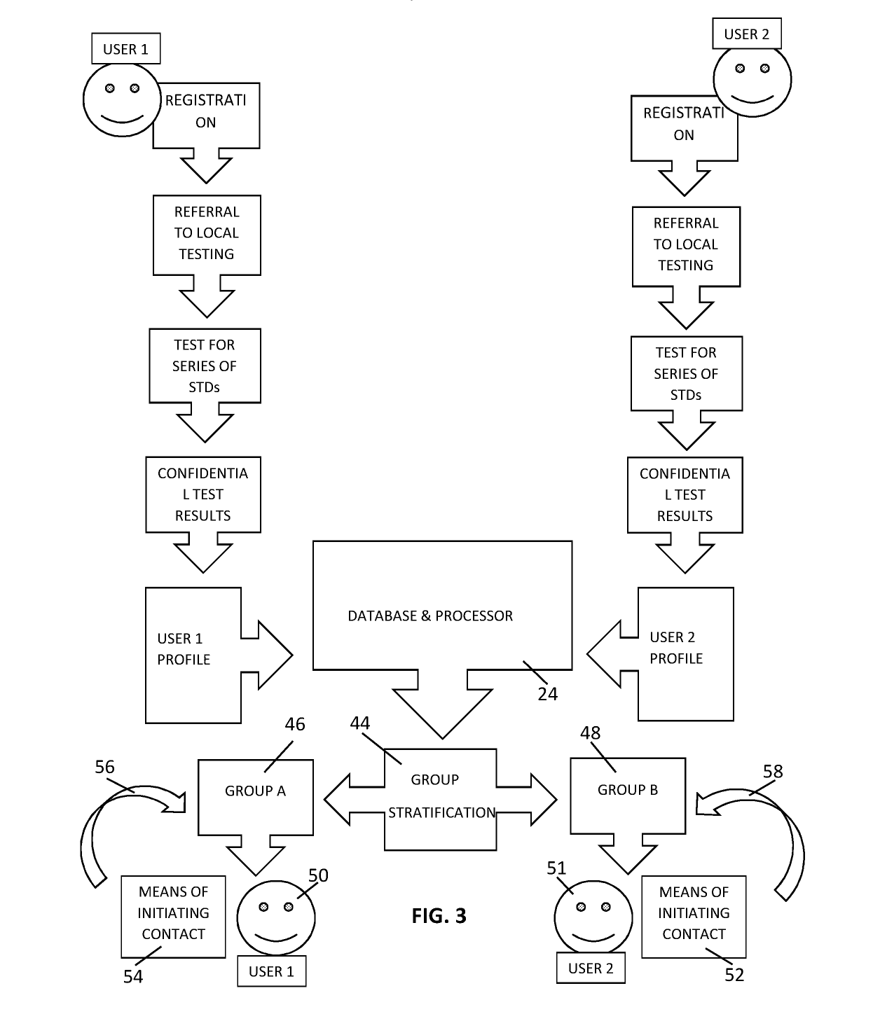

FIG. 3 illustrates a preferred embodiment of the invention that involves group stratification of user profiles. Following the creation of a user profile in the database 24, the processor stratifies each user profile into separate groups 46, 48 and possibly subgroups. These groups and subgroups can include a variety of factors including, but not limited to, STD infection type, strain, curability, user physical aptitudes, user social aptitudes, and/or user preferences in a prospective match. Following group stratification, the processor processes matches in the same mechanism as before by providing a prospective match profile to two users 50, 51 and if a match is approved by both the system provides a mechanism for each user to contact the other user 52, 54. If a match is not approved by both users, the system continues attempting to match each user to members within that user's group 56, 58.

While certain preferred embodiments are shown in the figures and described in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

What is claimed is:

1. A dating system, said dating system comprising the following steps:
the step of testing a first user for infection of a series of sexually transmitted diseases and testing a second user for infection of a series of sexually transmitted diseases to obtain test results for each of said first user and said second user indicating infection of said first user and said second user for the infection of a sexually transmitted disease;
the step of creating a profile of said first user and a profile of said second user, wherein said profile of said first user and said profile of said second user comprising said test results indicating the infection and/or absence of each sexually transmitted disease in said series of sexually transmitted diseases;
the step of matching compatible profiles of users by comparing the profiles of said first user and said second user for the infection and/or absence of each sexually transmitted disease;
the step of notifying said first user and said second user if said profiles of said first user and said second user are a match, wherein a match is defined as when said profiles of said first user and said second are positive or negative for the same sexually transmitted diseases in said series of tested for sexually transmitted diseases.

2. The dating system of claim 1, where said step of matching compatible profiles of users comprises using one or more processing devices to match compatible profiles of users.

3. The dating system of claim 1, wherein said step of notifying said at least one of said first user or said second user of a match comprises notifying said first user and said second user of a match without disclosing any of the actual test results from said testing of said first user to said second user or of said second user to said first user for the infection or absence of a sexually transmitted disease.

4. The dating system of claim 1, wherein said dating system step of matching compatible profiles of users by comparing the profiles of said users comprises stratifying said profiles into groups based on the results of said tests for the infection of a sexually transmitted disease.

5. The dating system of claim 1, wherein said step of notifying a user of a match comprises electronically mailing (emailing) a user when said user's profile has been matched with a second user's profile.

6. The dating system of claim 1, wherein said system comprises the step of notifying said first user of the results of said first user's test for the infection or absence of a sexually transmitted disease.

7. The dating system of claim 1, wherein said dating system comprises the step of providing an online platform for a user to register for the dating system.

8. The dating system of claim 7, wherein said dating system comprises the step of providing the location of sexually transmitted disease testing locations proximate to the location of a user who registered online for the dating system.

9. The dating system of claim 7, wherein said dating system comprises the step of providing a tele-medical treatment to a user diagnosed with the infection of a sexually treated disease.

10. The dating system of claim 7, wherein said dating system comprises the step of providing a referral to a user diagnosed with the infection of a sexually transmitted disease to a physician located proximate to the location of a user diagnosed with a sexually transmitted disease.

11. The dating system of claim 1, wherein said step of notifying said first user and said second user comprises providing said first user and said second user with the ability to approve of or disapprove of the results of the matching analysis.

12. The dating system of claim 11, wherein said step of notifying said first user and said second user comprises providing said first user and said second user with contact information after said first user and said second user approve of said results of the matching analysis.

13. The dating system of claim 4, wherein said system comprises providing the contact information for a user whose profile has been placed in a group to other users whose profile has been placed in the same group.

14. The dating system of claim 4, wherein dating system comprises the step of providing said system to a user of a pre-existing dating system.

15. The dating system of claim 1, wherein said system comprises the step of displaying to a user the duration of time elapsed since the user's most recent STD test.

16. The dating system of claim 1, wherein said system comprises the step of displaying the duration since a user's last STD test when displaying the profile of each user to a matching user's profile.

17. The dating system of claim 1, wherein said system comprises the step of providing a processor, wherein said step of matching compatible profiles of users by comparing the profiles of said first user and said second user for the infection and/or absence of each sexually transmitted disease is performed by said processor.
